(19) United States
(12) Patent Application Publication
(10) Pub. No.: US 2011/0173288 A1
(43) Pub. Date: Jul. 14, 2011

(54) NETWORK STORAGE SYSTEM AND RELATED METHOD FOR NETWORK STORAGE

(76) Inventor: Shu-Kai Ho, Hsinchu City (TW)

(21) Appl. No.: 12/722,534

(22) Filed: Mar. 12, 2010

(30) Foreign Application Priority Data
Jan. 12, 2010 (TW) 099100681

(51) Int. Cl. G06F 15/16; G06F 15/167; G06F 13/12

(52) U.S. Cl. 709/212; 709/234; 710/74

(57) ABSTRACT

A network storage system includes a first data buffer, a second data buffer, a pre-allocating module and a control module. The first data buffer is utilized for storing a storage data received from a network-base. The second data buffer is coupled to the first data buffer and includes a plurality of data buffering units. The pre-allocating module is coupled to the second data buffer and utilized for allocating the plurality of data buffering units to the second data buffer in advance. The control module controls the first data buffer to write the stored storage data into the plurality of data buffering units.

### BACKGROUND OF THE INVENTION

1. Field of the Invention

The present invention relates to a network storage architecture, and more particularly, to a network storage system and a related method for moving data by means of direct memory access (DMA).

2. Description of the Prior Art

A Network-attached storage (NAS) server is a storage device that is connected via the Internet and is dedicated to provide file access for computer systems by means of file-sharing network protocols such as SAMBA. The NAS server is capable of easily providing a network data-sharing mechanism with unlimited capacity expansion by means of a distributed architecture. Computer systems with a variety of operating systems can enjoy convenient file access services through the NAS server as long as they are connected to any node of the Internet. Hence, the data access speed of the NAS server has become an important topic of this field.

Generally speaking, a data length of an Ethernet packet is typically 1.5K bytes, wherein useful information may occupy a data length of 1-1460 bytes. A hard disk uses “a sector” as its data length unit. In other words, as for the NAS server, the data format of the data received from a network-base is different from the data format of the data being written into the hard disk. Hence, according to the prior art, the received data is reorganized by the operating system of the NAS server so as to perform a data format conversion. As an illustration, please refer to FIG. 1. FIG. 1 is a diagram of a conventional NAS server 100 according to the prior art. As shown in FIG. 1, the conventional NAS server 100 includes a first data buffer 110, a second data buffer 120, and a third data buffer 130. The first data buffer 110 is utilized for storing a storage data received from a network-base, wherein the storage data includes a plurality of frames with a size of 1.5 Kbytes (e.g., DS0, DS1, . . . ). The second data buffer 120 includes a plurality of memory pages, such as page0˜page14, wherein the plurality of memory pages are utilized for storing the storage data being written into a storage device (such as, a hard disk). When a user (such as, a PC 160) desires to write the storage data into the hard disk, the storage data (e.g., DS0, DS1, . . . ) is first stored into the first data buffer 110 in the kernel level of the operating system. After that, the NAS server 100 employs a processor (not shown), such as a central processing unit (CPU), to copy the storage data to the third data buffer 130 in the application level of the operating system, and then the third data buffer 130 temporarily stores the storage data. Until the collection of the storage data is completed, the storage data will be reorganized by the NAS server 100. Afterwards, the processor copies the reorganized data to the plurality of memory pages page0˜page14 of the second data buffer 120 in the kernel level of the operating system. Therefore, the storage data stored in the memory pages page0˜page14 of the second data buffer 120 can be written into the storage device (e.g., a hard disk) with a transfer protocol by the NAS server 100.

As one can see, complex data moving operations are required for the conventional NAS server 100, and thus the data access speed of the conventional NAS server 100 is seriously affected.

### SUMMARY OF THE INVENTION

It is one of the objectives of the claimed invention to provide a network storage system and a related method for network storage to solve the abovementioned problems.

According to one embodiment, a network storage system is provided. The network storage system includes a first data buffer, a second data buffer, a pre-allocating module and a control module. The first data buffer is utilized for storing a storage data received from a network-base. The second data buffer is coupled to the first data buffer, and includes a plurality of data buffering units for storing the storage data being written into a storage device. The pre-allocating module is coupled to the second data buffer, and utilized for allocating the plurality of data buffering units to the second data buffer in advance. The control module is coupled to the first data buffer and the second data buffer, for controlling the first data buffer to write the stored storage data into the plurality of data buffering units.

According to another embodiment, a method for network storage is provided. The method includes the following steps: providing a first data buffer for storing a storage data received from a network-base; providing a second data buffer having a plurality of data buffering units, wherein the second data buffer is utilized for storing the storage data being written into a storage device; allocating the plurality of data buffering units to the second data buffer in advance; and controlling the first data buffer to write the stored storage data into the plurality of data buffering units.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional NAS server according to the prior art.

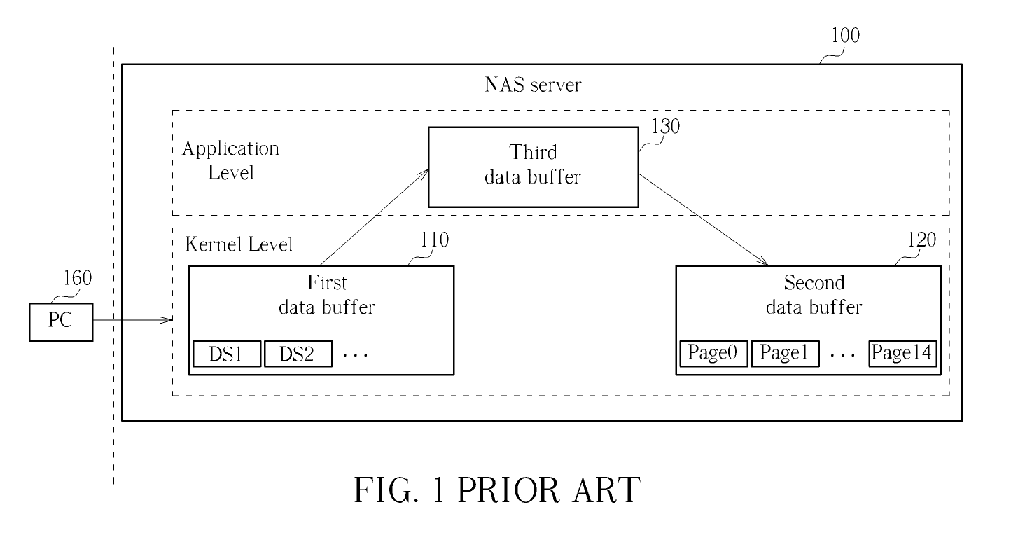

FIG. 2 is a diagram of a network storage system according to an embodiment of the present invention.

FIG. 3 is a flowchart illustrating a method for network storage according to an exemplary embodiment of the present invention.

### DETAILED DESCRIPTION

Certain terms are used throughout the following description and claims to refer to particular components. As one skilled in the art will appreciate, hardware manufacturers may refer to a component by different names. This document does not intend to distinguish between components that differ in name but in function. In the following discussion and in the claims, the terms “include”, “including”, “comprise”, and “comprising” are used in an open-ended fashion, and thus should be interpreted to mean “including, but not limited to . . . ”. The terms “couple” and “coupled” are intended to mean either an indirect or a direct electrical connection. Thus, if a first device couples to a second device, that connection may be through a direct electrical connection, or through an indirect electrical connection via other devices and connections.

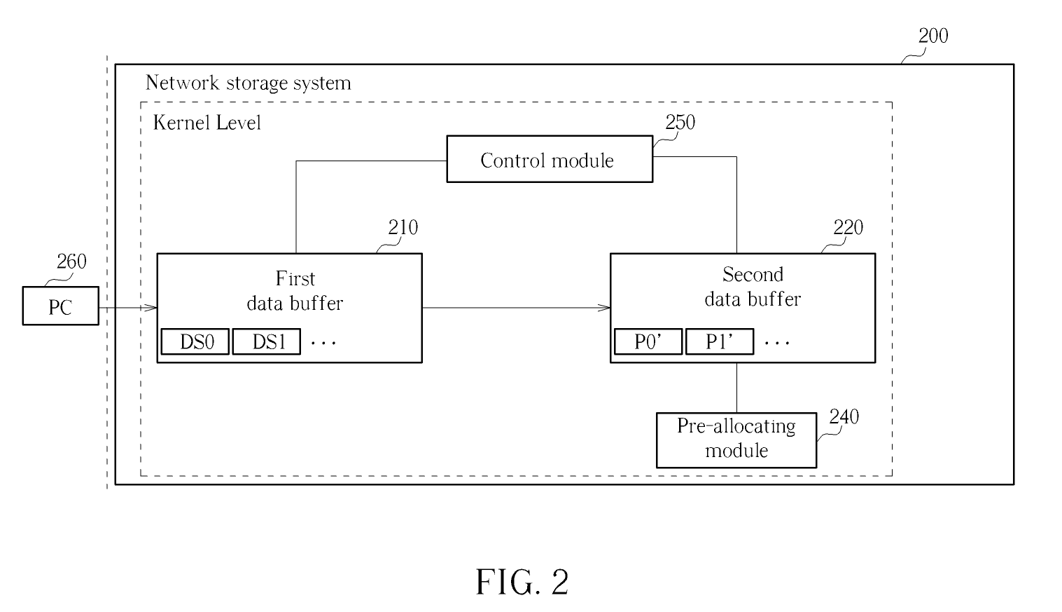

Please refer to FIG. 2. FIG. 2 is a diagram of a network storage system 200 according to an embodiment of the present invention. In this embodiment, a SAMBA server is used as an example for illustrating the network storage system 200. However, this is merely an example for illustrating features of the present invention and should not be seen as limitations of the present invention. Those skilled in the art should appreciate that any network storage system, which adopts the network storage architecture disclosed in the present invention without departing from the spirit of the present invention, should also belong to the scope of the present invention. As shown in FIG. 2, the network storage system 200 includes, but is not limited to, a first data buffer 210, a second data buffer 220, a pre-allocating module 240, and a control module 250. The first data buffer 210 is utilized for storing a storage data received from a network-base with a TCP/IP protocol, wherein the storage data includes a plurality of frames with a size of 1.5K bytes (e.g., DS0, DS1, . . . ). The second data buffer 220 includes a plurality of data buffering units P0˜P14. For example, the second data buffer 220 is implemented by a memory, and each of the data buffering units P0˜P14 is a memory page. Additionally, the second data buffer 220 is utilized for storing the storage data being written into a storage device (such as, a hard disk). The pre-allocating module 240 is coupled to the second data buffer 220, for allocating the plurality of data buffering units P0˜P14, which is being stored into the hard disk, to the second data buffer in advance.

Furthermore, the control module 250 is coupled to the first data buffer 210 and the second data buffer 220, for controlling the first data buffer 210 to write the stored storage data (e.g., DS0, DS1, . . . ) into the plurality of data buffering units P0˜P14. Be noted that in this embodiment, each of the plurality of data buffering units is implemented by taking a memory page as an example, but this in no way should be considered as limitations of the present invention. In other embodiments, any storage space can be defined as a data buffering unit disclosed in the present invention.

In addition, in a preferred embodiment, the first data buffer 210 directly writes the stored storage data into the plurality of data buffering units P0˜P14 by means of direct memory access (DMA), but the present invention is not limited to this only. Under the condition that the plurality of data buffering units P0˜P14 are allocated to the second data buffer 220 in advance without departing from the spirit of the present invention, a processor (such as a CPU) may be adopted to write the storage data originally stored in the first data buffer 210 into the plurality of data buffering units P0˜P14, which should also belong to the scope of the present invention.

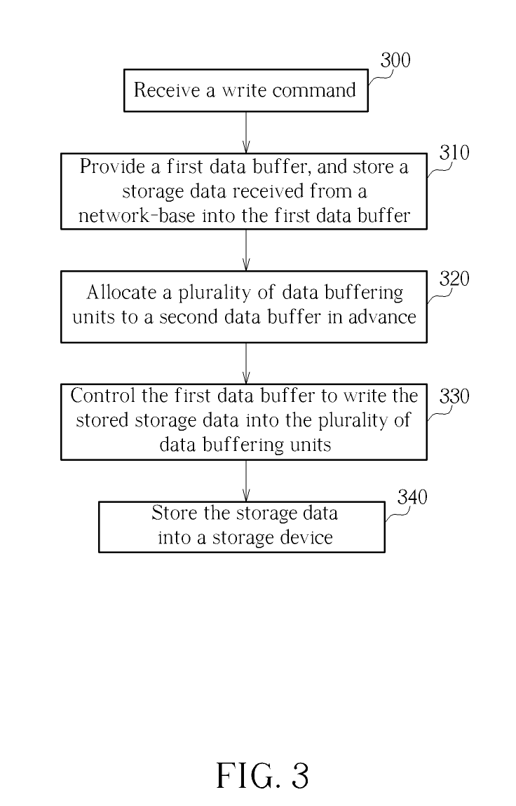

Please refer to FIG. 3. FIG. 3 is a flowchart illustrating a method for network storage according to an exemplary embodiment of the present invention. Please note that the following steps are not limited to be performed according to the exact sequence shown in FIG. 3 if a roughly identical result can be obtained. The method includes, but is not limited to, the following steps:

Step 300: Receive a write command.

Step 310: Provide a first data buffer, and store a storage data received from a network-base into the first data buffer.

Step 320: Allocate a plurality of data buffering units to a second data buffer in advance.

Step 330: Control the first data buffer to write the stored storage data into the plurality of data buffering units.

Step 340: Store the storage data into a storage device.

In the following descriptions, how each element operates can be known by collocating the elements shown in FIG. 2 together with the steps shown in FIG. 3. In a preferred embodiment, when a remote user (such as, a PC 260) desires to write a file, a write command is received by the network storage system 200 (Step 300). At this time, the first data buffer 210 is utilized for storing the storage data (e.g., DS0, DS1, . . . ) received from the network-base with a TCP/IP protocol (Step 310). After that, the pre-allocating module 240 allocates the plurality of data buffering units P0˜P14, which is being stored into the storage device, to the second data buffer 220 in advance (Step 320). As a result, the control module 250 controls the first data buffer 210 to write the stored storage data into the plurality of data buffering units P0˜P14 by means of direct memory access (DMA) (Step 330). When the network storage system 200 (e.g., a SAMBA server) desires to write the file into the storage device, the network storage system 200 directly writes the storage data from the plurality of data buffering units P0˜P14 into the storage device with a transfer protocol (Step 340).

The abovementioned embodiments are presented merely for describing the features of the present invention, and in no way should be considered to be limitations of the scope of the present invention. In summary, the present invention provides a network storage system and a related method. By adopting the pre-allocating module disclosed in the present invention to change the data transmission path, not only can the data moving number be reduced, but the performance of data storage can also be improved.

Those skilled in the art will readily observe that numerous modifications and alterations of the device and method may be made while retaining the teachings of the invention.

What is claimed is:

1. A network storage system, comprising:
a first data buffer, for storing a storage data received from a network-base;
a second data buffer, coupled to the first data buffer, the second data buffer comprising a plurality of data buffering units for storing the storage data being written into a storage device;
a pre-allocating module, coupled to the second data buffer, for allocating the plurality of data buffering units to the second data buffer in advance; and
a control module, coupled to the first data buffer and the second data buffer, for controlling the first data buffer to write the stored storage data into the plurality of data buffering units.

2. The network storage system of claim 1, wherein each of the plurality of data buffering units is a memory page.

3. The network storage system of claim 1, wherein the first data buffer directly writes the stored storage data into the plurality of data buffering units by means of direct memory access (DMA).

4. The network storage system of claim 1, being a SAMBA server.

5. The network storage system of claim 1, wherein the storage device is a hard disk.

6. A method for network storage, comprising:
providing a first data buffer, and storing a storage data received from a network-base into the first data buffer;
providing a second data buffer having a plurality of data buffering units, wherein the second data buffer is utilized for storing the storage data being written into a storage device;
allocating the plurality of data buffering units to the second data buffer in advance; and
controlling the first data buffer to write the stored storage data into the plurality of data buffering units.

7. The method of claim 6, wherein each of the plurality of data buffering units is a memory page.

8. The method of claim 6, wherein the first data buffer directly writes the stored storage data into the plurality of data buffering units by means of direct memory access (DMA).

9. The method of claim 6, wherein the method is applied to a SAMBA server.

10. The method of claim 6, wherein the storage device is a hard disk.
